(19) United States
(12) Patent Application Publication
(10) Pub. No.: US 2024/0152834 A1
(43) Pub. Date: May 9, 2024

(54) SYSTEM AND METHOD FOR FACILITATING PRODUCTION OF A MULTIMEDIA PROJECT

(71) Applicant: Mario RAMIREZ, Sherman Oaks, CA (US)

(72) Inventor: Mario RAMIREZ, Sherman Oaks, CA (US)

(21) Appl. No.: 18/052,533

(22) Filed: Nov. 3, 2022

(51) Int. Cl. G06Q 10/0631; G06Q 10/10

(52) U.S. Cl. CPC G06Q 10/06313; G06Q 10/063118; G06Q 10/103

(57) ABSTRACT

A computer-implemented method of facilitating production of a multimedia project involving multiple entities and defined at least in part by a plurality of production sets. Set information including set names and dates corresponding to the production sets is received at a web server. Notifications relating to changes associated with the production sets are sent to electronic devices of the multiple entities. A search for potential set locations corresponding to one of the production sets is then performed based upon the set information. This may include providing a search query to an application programming interface (API) of a location search service and receiving a corresponding list of one or more set locations returned by the location search service in response to the search query. Suggested production locations corresponding to the selected set location are generated in response to the selected set location.

### FIELD

This application is generally related to the film and television industries and, in particular, to tools for managing multimedia projects such as television series and feature length films produced by those industries.

### BACKGROUND

Television and film production is a logistically challenging process involving film crews and other associated support staff. One member of the film crew, often referred to as a location manager, is responsible for finding and securing locations to be used, obtaining required governmental permits, and coordinating other logistics associated with the film or television production.

The location manager or the manager's designee is responsible for the initial scouting of all the set locations used in a film or television production. This may involve taking into account all the logistics necessary for the production to function as well as other constraints applicable to the production. These may include, for example, budgetary restrictions of the production, local permitting fees and regulations, proximity to other set locations, security, production services, crew parking, and the like.

Once a given set location has been determined to meet the requirements of the production, it is necessary to schedule dates for set preparation, filming and cleanup, and negotiate applicable fees with the property owner. It will also generally be necessary to apply for required permits, arrange for security and parking for crew and commercial vehicles, and procure temporary facilities for use by production personnel, talent, and other crew.

Conventional approaches for performing these tasks tend to be inefficient and rely upon the acquired expertise of select individuals, which is not easily shared or leveraged across multiple productions. Collaboration, to the extent it occurs at all, is often off-line and inefficient or comprised of multiple, private text message strings. Moreover, any changes to plans or activities associated with a production are generally communicated manually, which creates the opportunity for errors and inadvertent exclusion of team members. Finally, reporting, tracking and managing production costs becomes a tedious and labor-intensive process.

### SUMMARY

Disclosed herein is a computer-implemented method of facilitating production of a multimedia project wherein multiple entities are associated with the multimedia project. The multimedia project is defined at least in part by a plurality of production sets. The method includes receiving, at a web server, set information communicated over a communication network. The set information includes a plurality of set names and a plurality of dates corresponding to the plurality of production sets. The method further includes at least one of generating or updating a plurality of record elements in a database based upon the set names and dates. The plurality of record elements corresponds to the plurality of production sets. Notifications relating to changes associated with one or more of the production sets are sent to electronic devices of the entities associated with the multimedia project. A search for potential set locations corresponding to one of the production sets is then performed based upon the set information. Performance of the search may include providing a search query to an application programming interface (API) of a location search service and receiving a corresponding list of one or more set locations returned by the location search service in response to the search query. The method further includes generating, in response to selection of one of the potential set locations, a plurality of suggested production locations corresponding to the selected set location. Selection information identifying one of the suggested production locations is then received at the web server. A record element corresponding to the selected production sets is then updated based upon the selection information. One or more documents relating to the proposed order may be received at the web server and stored in association with the multimedia project.

In another aspect the disclosure relates to a computer-implemented method of providing information relating to vendor ordering to facilitate production of a multimedia project. The method includes receiving, at a web server, vendor selection information identifying a vendor selected to provide services relating to the multimedia project. A notification of selection of the vendor is then sent to an electronic device of the vendor. The method further includes receiving, at the web server, service selection information identifying one or more services to be provided by the vendor. A proposed order is then created using a shared order form. The proposed order includes order information identifying the vendor and the one or more services and is accessible to the electronic device of the vendor and to an electronic device of a production user over a communications network wherein the one or more services are collaboratively defined by the vendor and the production user through editing of the shared order form. The method also includes receiving, at the web server, an indication of entities to be notified of changes to the proposed order. Vendor update information containing updates to the proposed order made by the vendor, and an approval of the proposed order as modified to include the vendor update information, are also received at the web server. The method may further include sending update notifications indicating the changes made to the proposed order based upon the vendor update information.

### BRIEF DESCRIPTION OF THE DRAWINGS

The present application may be more fully appreciated in connection with the following detailed description taken in conjunction with the accompanying drawings, wherein:

FIG. 1 is a block diagram of a system for facilitating production of a multimedia project in accordance with the disclosure.

FIG. 2 is a block diagram illustrating the principal components of a production user device in accordance with an embodiment.

FIG. 3 provides an illustrative representation of exemplary information sharing between and among the production database, production team members, vendors and studio personnel in accordance with the disclosure.

FIG. 4 is a flowchart of an exemplary process for compiling and sharing set lists in accordance with the disclosure.

FIG. 5 illustrates interaction with a simplified user interface generated by the production user application.

FIG. 6 is a flowchart of a computer-implemented process for placing and managing orders with vendors in accordance with the disclosure.

FIG. 7 is a flowchart depicting a more detailed process of placing a vendor order with a specific vendor for a production set

FIG. 8 illustrates a simplified user interface generated by the production user application through which specific service locations may be specified.

FIGS. 9-13 are screenshots of exemplary user interfaces generated by the production user application.

FIGS. 14-23 are screenshots of exemplary user interfaces generated in connection with placing a vendor order with a specific vendor for a production set.

FIG. 24 is a flowchart illustrating a process of managing a show team comprised of production team members having access to the production user application.

FIGS. 25-28 are screenshots of exemplary user interfaces generated as part of the management of a show team described with reference to FIG. 24.

FIG. 29 is a flowchart illustrating a process of adding orderable items into the system of FIG. 1.

FIGS. 30-33 are screenshots of exemplary user interfaces generated as part of the process described with reference to FIG. 29.

FIG. 34 is an illustration of the results of various budget calculations selectively available through the system of FIG. 1 to production users, vendors and studio users.

### DETAILED DESCRIPTION OF EMBODIMENTS

Various embodiments are described below with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

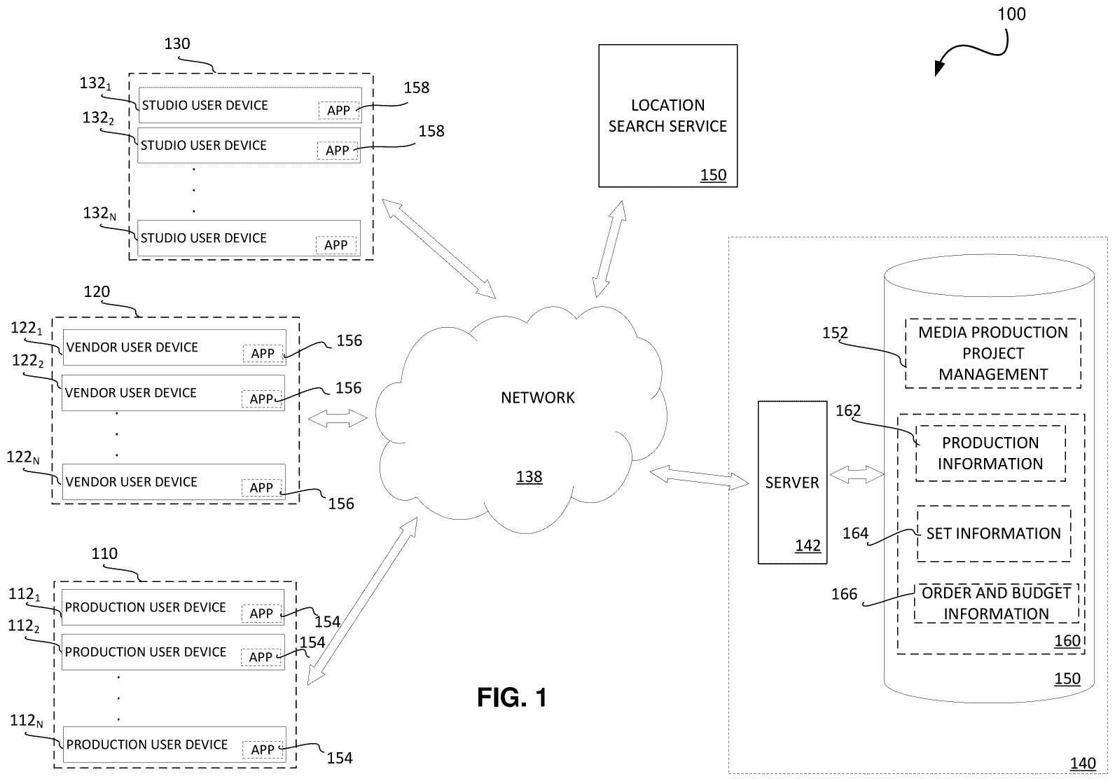

Attention is now directed to FIG. 1, which is a block diagram of a system 100 for facilitating production of a multimedia project in accordance with the disclosure. In one embodiment multiple entities are associated with the multimedia project. These entities may include, for example, production team members 110, vendors 120 and studio personnel 130. The production team members 110, vendors 120 and studio personnel 130 respectively utilize production user devices 112, vendor user devices 122 and studio user devices 132 to coordinate production of the multimedia project in the manner described hereinafter.

The production user devices 112, vendor user devices 122 and studio user devices 132 may include cellular phones, desktop computers, laptop computers, tablet computers and other electronic devices having sufficient processing and communication capabilities to carry out the tasks described herein. The user devices 112, 122 and 132 are in communication over a network 138 with a server complex 140 having at least one server 142 and memory storage 150.

The at least one server 142 of server complex 140 is configured to execute a centralized component of a media project management application 152 operative to enable the user devices 112, 122 and 132 to coordinate media project production operations as described hereinafter. The application 152 communicates with a production user application 154 within the production user devices 112, a vendor user application 156 within the vendor user devices 122 and a studio user application 158 within the studio user devices 132. The memory storage 150 of server complex 140 includes a production database 160 including production information 162, set information 164 and order and budget information 166.

In one embodiment the application 152 configures server 142 to function as a platform enabling film and television production teams 110 to collaborate with production vendors 120 on ordering and delivering services and to share information with studios 130. As is discussed below, the application 152 provides each of these user groups 110, 120, 130 with a unique interface to share and collaborate on production and set information. In this way the application 152 ensures that all parties are kept up to speed on the changing schedules and demands of productions.

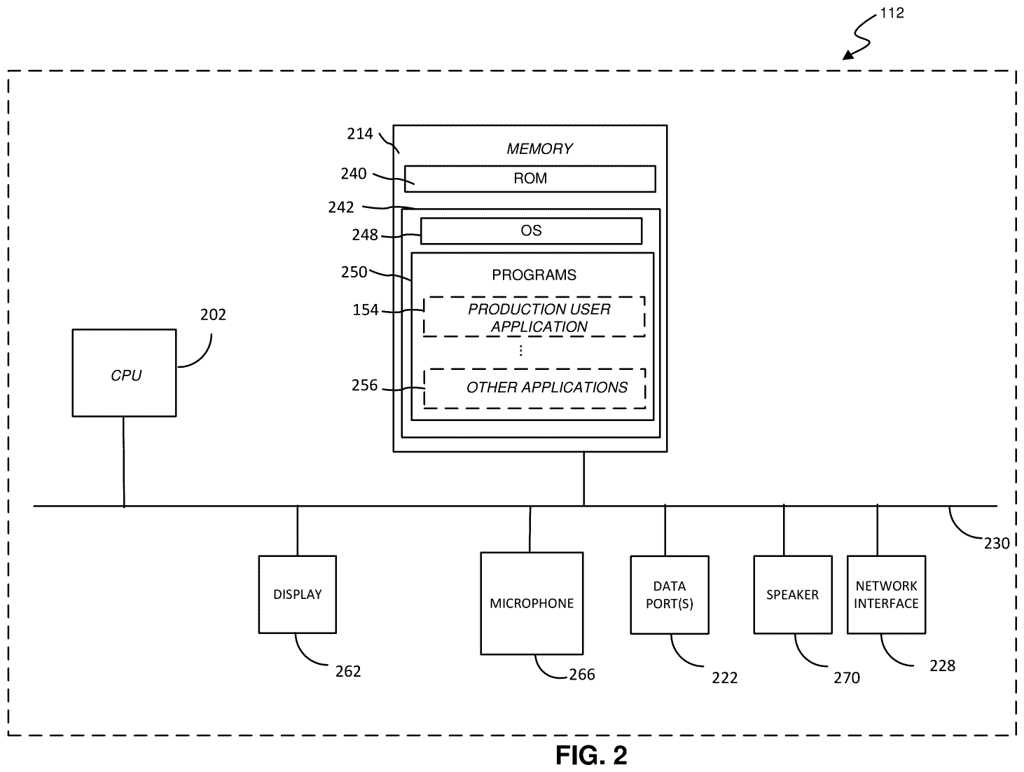

Turning now to FIG. 2, a block diagram is provided which illustrates the principal components of a production user device 112 in accordance with an embodiment. User device 112 may be used to implement a mobile communication device such as a cellular phone, a desktop computer, a workstation, a laptop computer, or other type of communication device. As shown, user device 112 includes a central processing unit (“CPU”) 202, system memory 214, data port(s) 222, and network interface 228 connected by system bus 230. System bus 230 may include a memory bus or memory controller, a peripheral bus, and a local bus, and may utilize any of a various known bus architectures. Network interface 228 may provide an Ethernet, Wi-Fi, GSM, Bluetooth or other wired, wireless, or cellular network interface for connecting user device 112 to an external network, such as the Internet. Data port 222 may be any data port as is known in the art for interfacing with an external accessory using a data protocol such as RS-232, USB, or Firewire.

In one embodiment system memory 214 may include a read-only memory (ROM) 240 and random access memory (RAM) 242. The ROM 240 generally stores foundational routines to convey information between components of user device 112. RAM 242 stores an operating system (OS) 248, such as, for example, iOS®, Android®, Windows®, Linux or other type of OS. System memory 214 also stores application programs 250 currently executing as processes on the user device 112. These applications 250 may include, for example, the production user application 154 and other applications 256. CPU 202 also communicates with a display 262, microphone 266 and a speaker 270.

Vendor user devices 122 and studio user devices 132 may be configured substantially similarly to production user devices 112. However, vendor user devices 122 each instantiate a vendor user application 156 rather than a production user application 154. Similarly, studio user devices 132 each instantiate a studio user application 158 rather than a production user application 154.

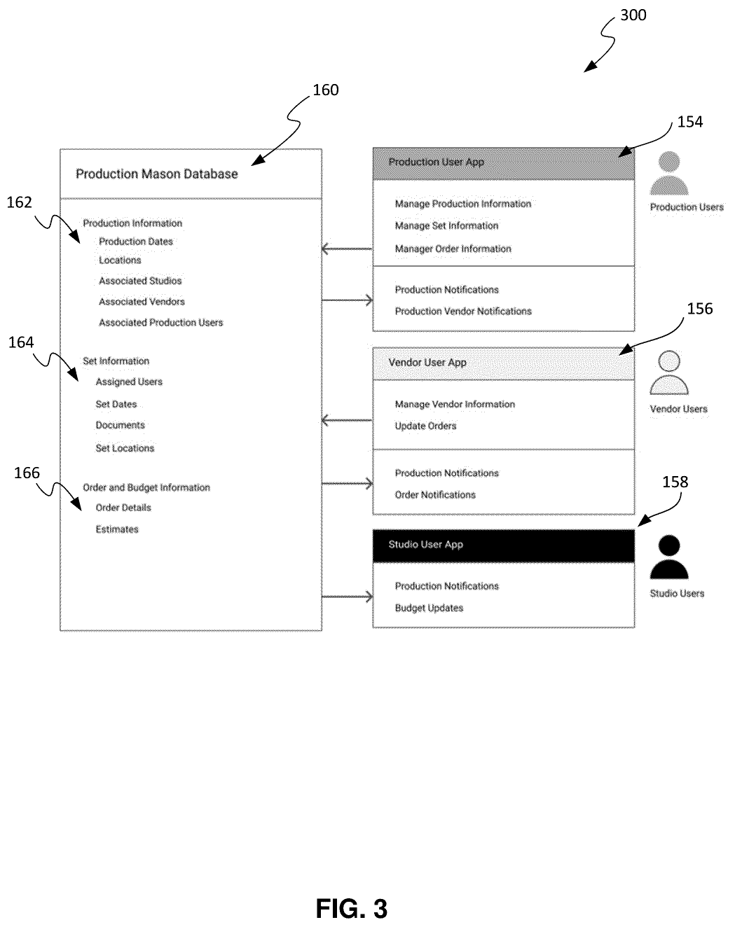

FIG. 3 provides an illustrative representation 300 of exemplary information sharing between and among the production database 160, production team members 110, vendors 120 and studio personnel 130 in accordance with the disclosure. Such information sharing enables, for example, film and television production team members 110 to collaborate with production vendors 120 on ordering and delivering services and to share information with studio personnel 130. As shown, the production information 162 includes information relating to production dates, production locations, associated studios, associated vendors and associated production users. The set information 164 includes information pertaining to assigned users, set dates, documents, and set locations. The order and budget information 166 includes information concerning order details and estimates. As is discussed below, while accessing the same production database 160, each of these user groups (i.e., production team members 110, vendors 120 and studio personnel 130) will have a unique interface to share and collaborate on production and set information. This advantageously enables all parties to be apprised of the changing schedules and demands of productions.

Again referring to FIG. 3, in one embodiment the production user application 154 is configured to interface with the production database 160 in order to manage production information, manage set information and manage order information as described hereinafter. The production user application 154 also receives production notifications and production vendor notifications from the production database 160. The vendor user application 156 is configured to interface with the production database 160 in order to manage vendor information and to update orders as described hereinafter. The vendor user application 156 also receives production notifications and order notifications from the production database 160. The studio user application 158 is configured to receive production notifications and budget updates from the production databases in the manner described hereinafter.

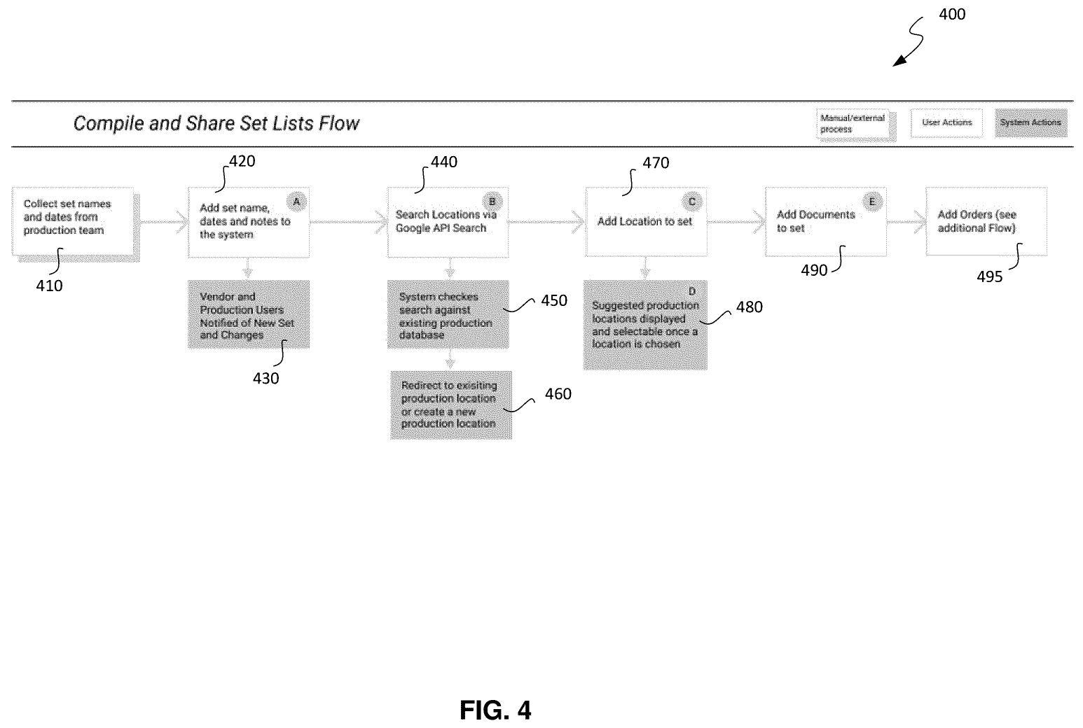

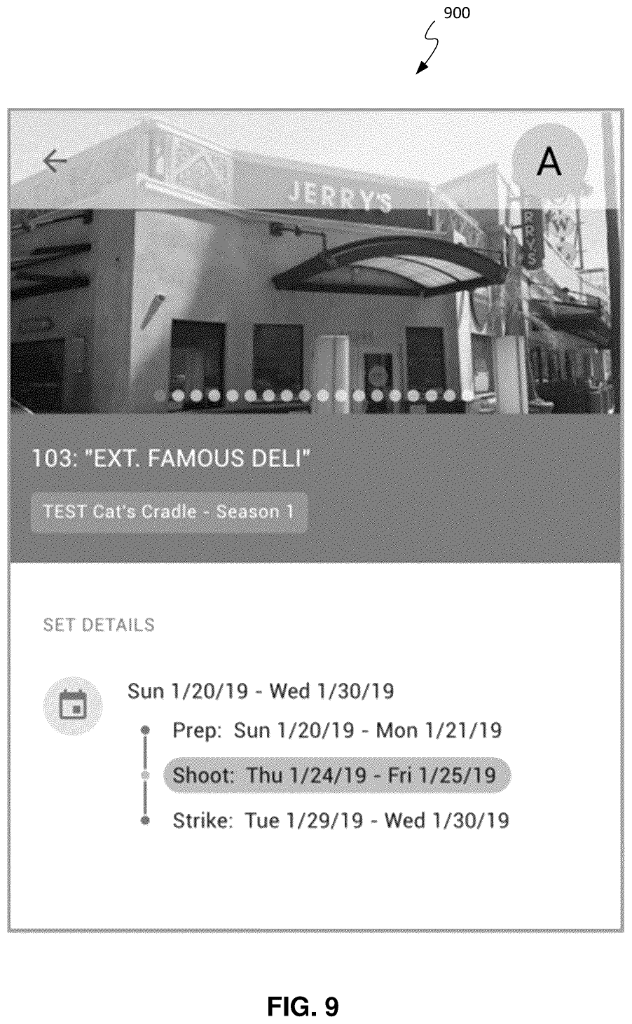

Attention is now directed to FIG. 4, which is a flowchart of an exemplary process 400 for compiling and sharing set lists in accordance with the disclosure. As used herein, the term “set list” refers to a collection of sets from a production script that is used by production teams and location managers for planning a production schedule. The process 400 is initiated by collecting set names and dates associated with a multimedia project from members of the production team 110. The collected set names and dates will generally correspond to names of the general set locations at which, for example, filming of a film or television production will occur on the specified dates. In one embodiment the set names and dates are provided in a list and in other embodiment the set names and dates may be harvested from a script of the film or television production. Once these set names and dates are stored within the production database (stage 420), the application 152 is configured to notify vendors 120 and production users 110 previously associated with the multimedia project (e.g., film or television production) of the creation of a new set and any changes to it (stage 430). FIG. 9 is a screen shot of an exemplary user interface 900 generated by the production user application 154 which depicts details of a particular production set.

Referring again to FIG. 4, a search may then be performed for specific set locations corresponding to each production set identified within the set list. This search may performed by, for example, providing a search query including character string corresponding to the name of the desired set location to the API of a location search service 150 (stage 440). As an example, consider the case in which the character string “Hollywood fo” is provided by server complex 140 to the API of a location search service 150 (FIG. 1). In this case a corresponding list of potential set locations is returned to the server complex 140 by the location search service 150. In addition, the application 152 may be configured to check the search query against information on set locations previously used or compiled in connection with prior multimedia projects facilitated by the system 100 and stored within the production database 160 (stage 450). The additional set location information retrieved from the database 160 may comprise, for example, additional information concerning the set locations provided by the search service 150 and/or additional set locations not identified by the search service 150. For example, if the location search service 150 is a public domain service such as Google Maps, then the additional information retrieved from the database may include specific production contact names, phone numbers and other details associated with particular set locations that are not obtainable through Google Maps. For example, this additional information could include potential locations for a crew base camp or crew parking located nearby the actual set location at which filming may be scheduled to occur. For example, the production database 160 may include information indicating that a bank located nearby a potential set location is closed on the date (e.g., a Saturday) that filming is scheduled to occur at the set location, thereby potentially providing a location for crew parking. The production database 160 could further include the name and contact details for a representative of the bank through which arrangements could be made to utilize the banks' parking facilities.

In one embodiment these production location may be evaluated and, if appropriate, production users 110 and vendors 120 may be redirected to one of these existing production locations or a new production location may instead be created (stage 460). Such redirection or suggestion of particular production locations may be based upon, for example, the size of the associated filming crew, recommendations concerning venues previously utilized at certain production locations, the nature or subject matter of the multimedia project (e.g., comedy, thriller, etc.), and other factors.

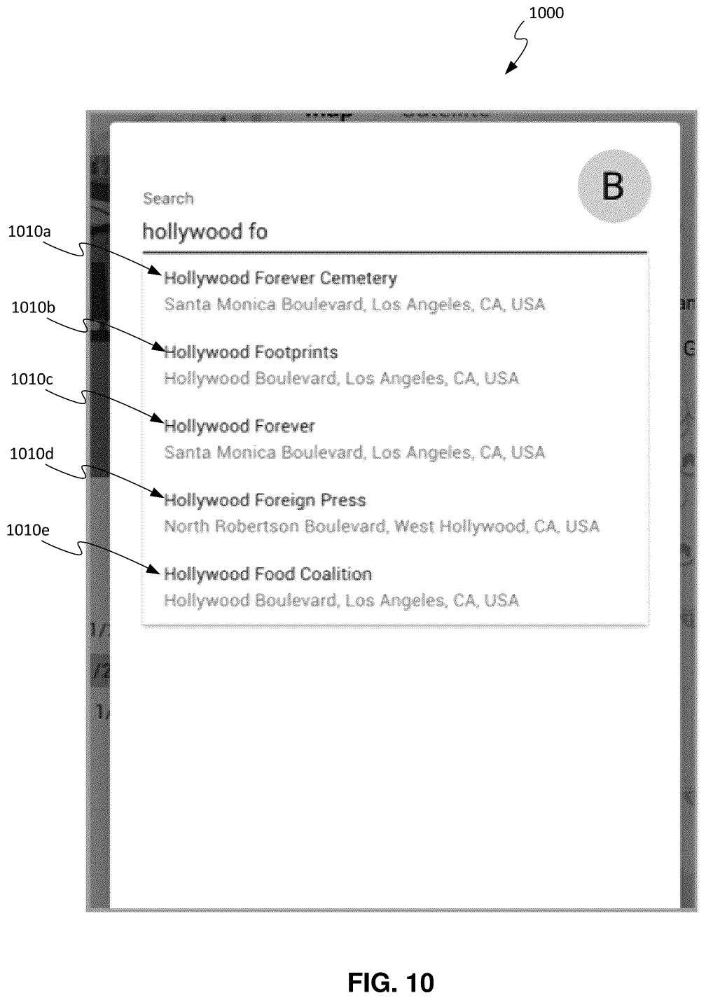

FIG. 10 provides a screen shot of exemplary user interface 1000 generated by the production user application 154 which includes potential set locations corresponding to a submitted character string query. In one embodiment both the search service 150 and production database 160 are the source of one or more of the potential locations 1010.

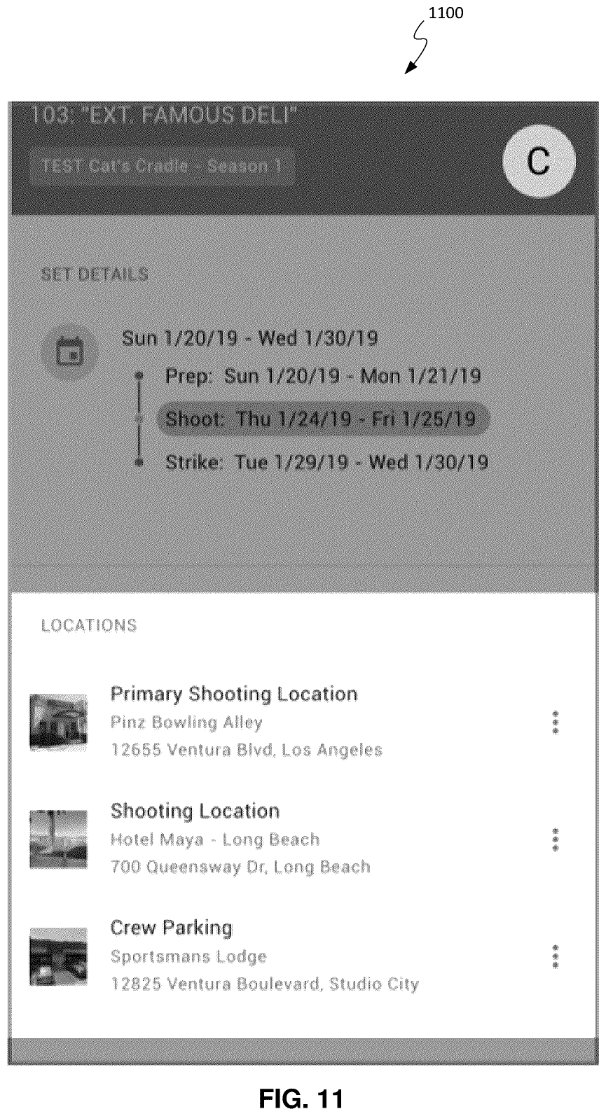

Again referring to FIG. 4, once a suggested set location has been accepted it is added as a record to the set information 164 for the multimedia project (stage 470). The set information 164 may further include items such as, for example, permits, hand drawn maps, preparation time, cleanup time, supporting locations for parking, and other information which may be necessary or helpful to access and utilize a set location. See FIG. 11.

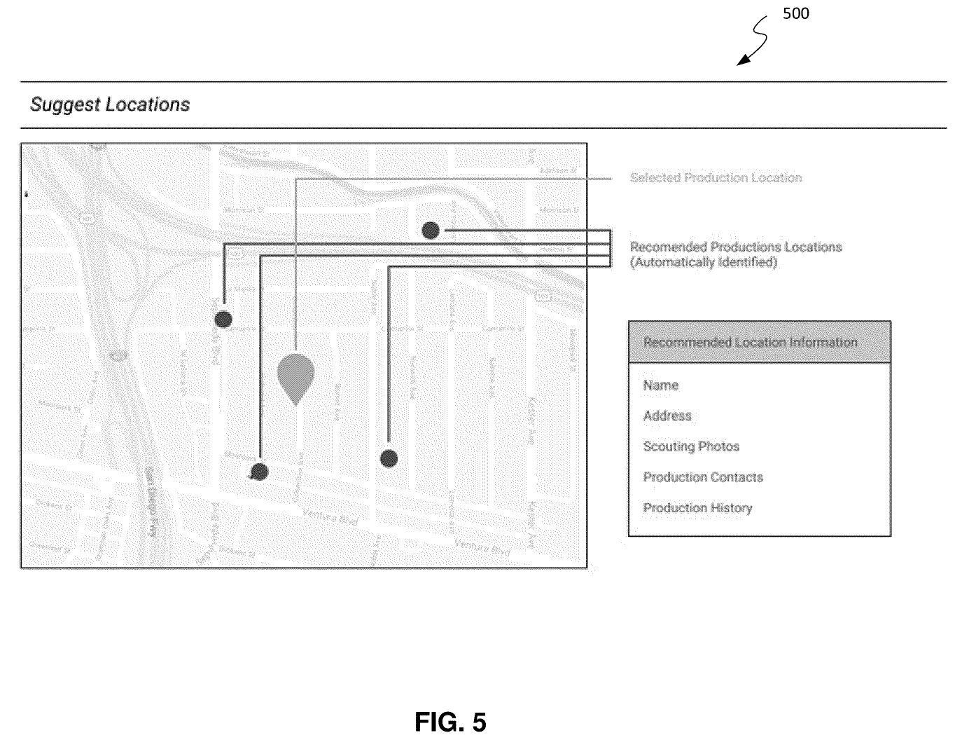

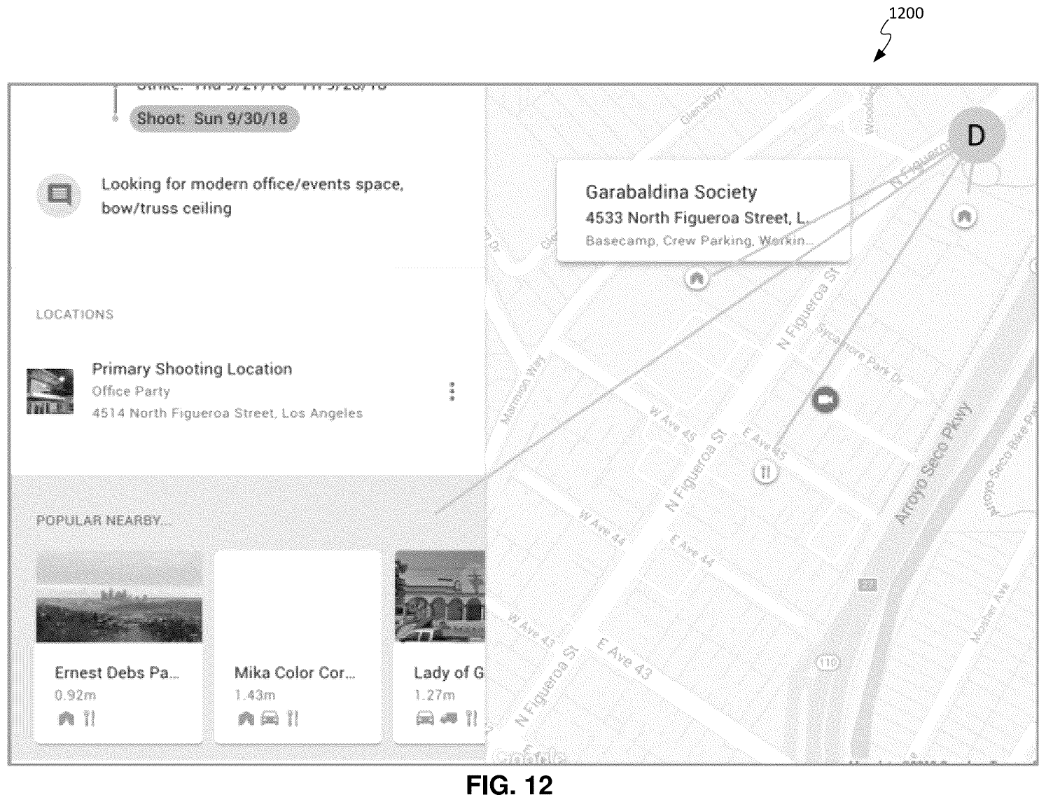

Suggested production locations associated with the set location are then displayed by the production user application 154 and are selectable by a user (stage 480). This is illustrated by FIG. 5, which illustrates interaction with a simplified user interface 500 generated by the production user application 154. As shown, the user interface 500 renders on a map a group of potential filming and support locations for production users to select. Tapping on these locations reveals relevant data that will help users decide whether the location is appropriate for their production. FIG. 12 is a screenshot of a user interface 1200 generated by the production user application 154 providing a more detailed view of a set of production locations. As shown in FIG. 12, a primary filming location, a basecamp, and crew parking locations are identified.

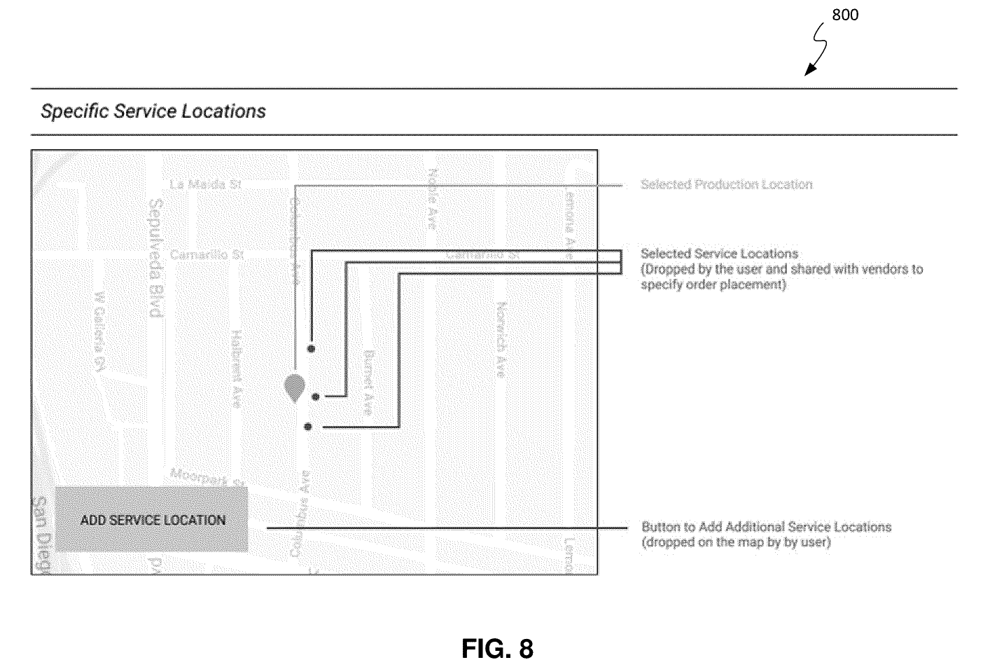

In addition to selecting production locations, production users 110 can also select the exact position for services to be set up, delivered, etc. by vendors 120. This is illustrated by FIG. 8, which illustrates interaction with a simplified user interface 800 generated by the production user application 154. As shown, the user interface 800 renders on a map a group of selected service locations associated with a selected production location. The selected service locations may be “dropped”, i.e., specified, by a production user 110 and shared with vendors 120 to specify order placement. New service locations may be added by production users 110 by selecting the ADD SERVICE LOCATION button and then specifying the new service location via the user interface 800.

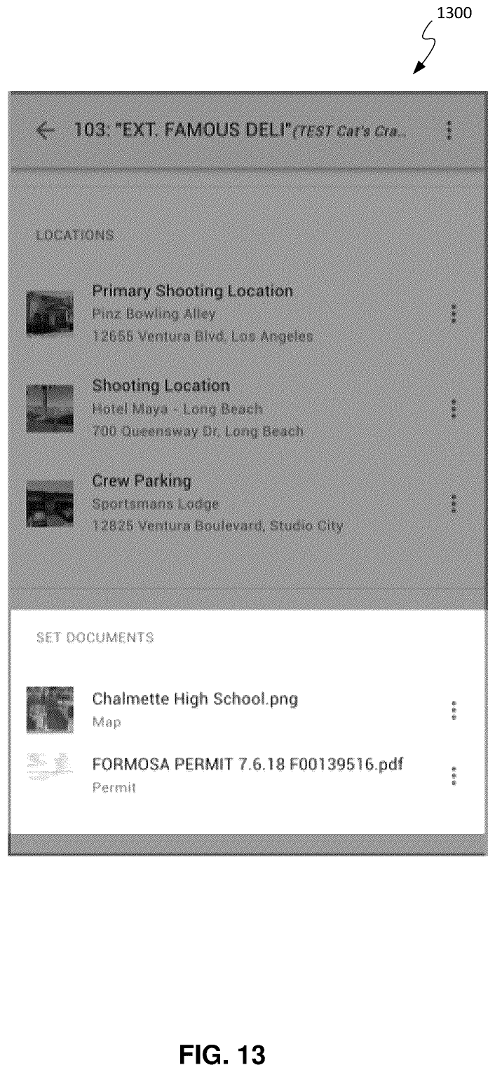

Turning again to FIG. 4, once a location for a production set has been identified, various ancillary documents may be added to a data structure for the production set created in the production database 160 (stage 490). As an example, an overlay document consisting of an annotated satellite view of the production location may be added to the data structure. The annotations may relate to, for example, ingress and egress locations, guard locations, trash collection locations, and the like. FIG. 13 is a screen shot of a user interface 1300 generated by the production user application 154 which includes a listing of various set documents associated with a production set.

Various types of orders placed with vendors may also be added to the data structure for the production set created in the production database 160 (stage 495). These orders will generally relate to products or services to be provided or consumed at the production location (e.g., the filming location) and supporting locations associated with a given set location. For example, orders placed with vendors may relate to sanitation, security, food catering and the like.

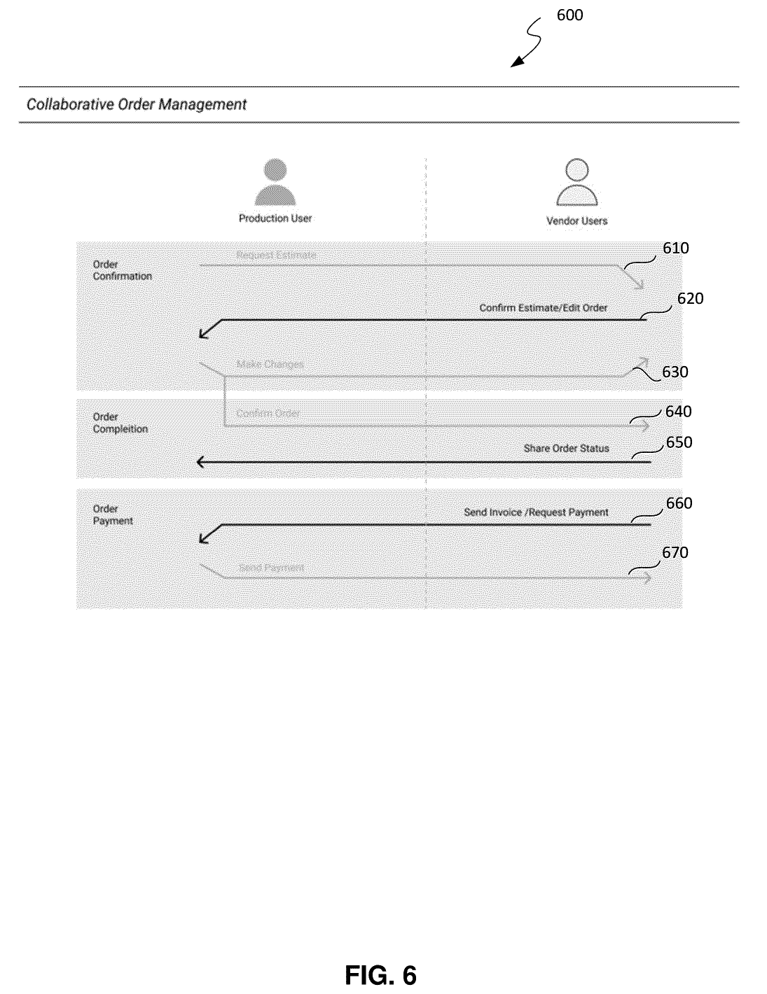

Attention is now directed to FIG. 6, which is a flowchart of a computer-implemented process 600 for placing and managing orders with vendors in accordance with the disclosure. In general, the process 600 enables production users 110 and vendor users 120 to collaboratively create orders via a shared order form. In one embodiment both production users 110 and vendor users 120 types may edit the shared order form and, once it is completed, submit it for approval and payment. Referring to FIG. 6, the process 600 is initiated when a production user 110 requests an estimate for a product or service provided by a vendor user 120 via a shared form accessible to both the production user application 154 of the production user 110 and the vendor user application 156 of the vendor user 120 (stage 610). The vendor user 120 confirms the estimate and/or edits the order (stage 620). In response, the production user 110 may make changes to the order (stage 630) and/or confirm the order (stage 640). The vendor user 120 may then share order status with the production user (stage 650) and send a corresponding invoice or otherwise request payment (stage 660). The process 600 concludes upon the production user 100 sending payment to the vendor user (stage 670).

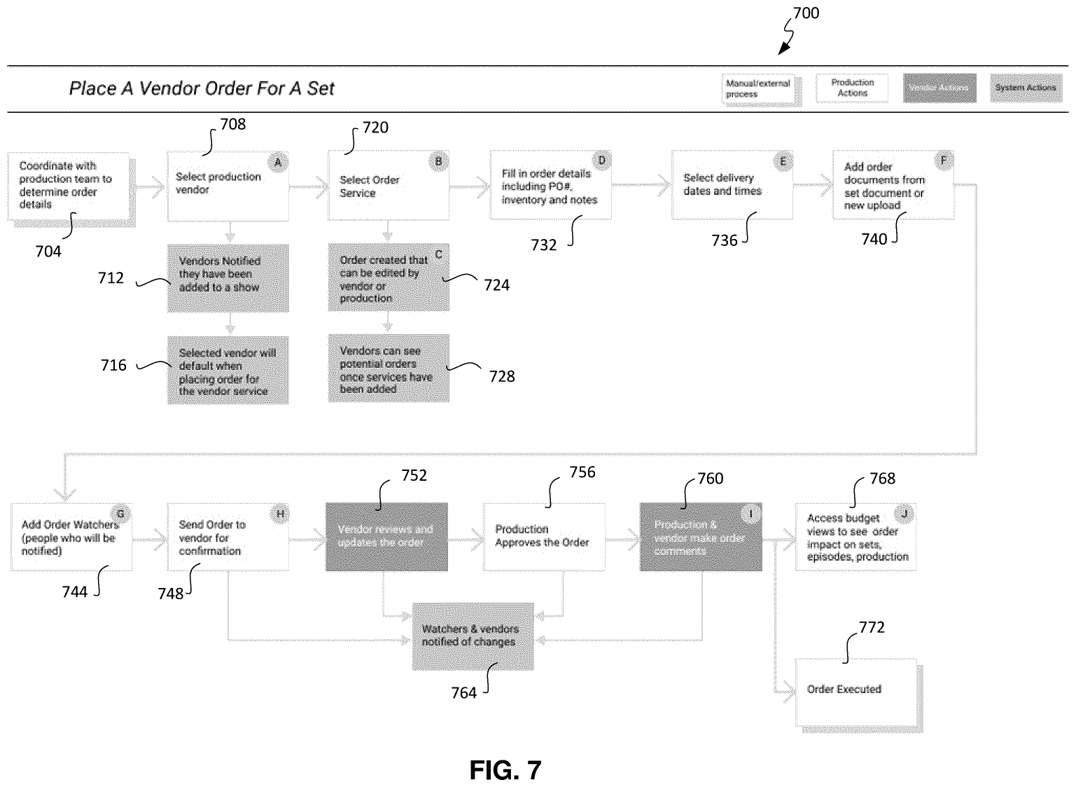

Turning now to FIG. 7, a flowchart depicting a more detailed process 700 of placing a vendor order with a specific vendor 120 for a production set is provided. Vendor orders are generated by location managers to meet needs for a given set. For example, orders may be placed for vendors of services such as tent rentals, security guards, portable toilets and garbage collection.

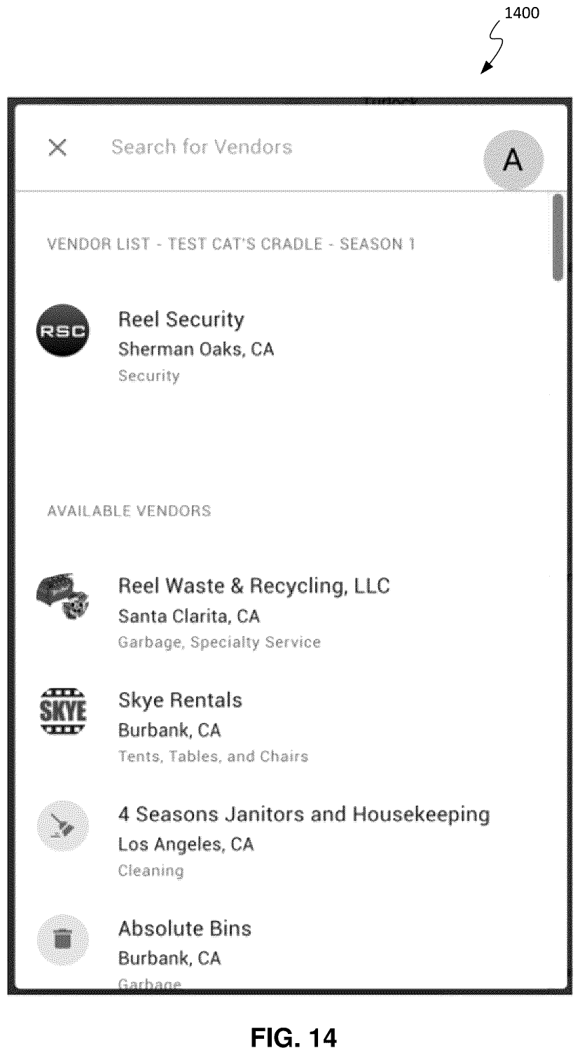

The process 700 is initiated when a production user 110 coordinates with a production team to determine details of the order to be placed (stage 704). A particular production vendor may then be selected, typically from among multiple vendor options (stage 708). See the screenshot 1400 of FIG. 14 generated by production user application 154. In one embodiment the multiple vendor options include vendors that have been used on other shows or productions supported by the system 100. Vendors are notified when they have been added to a show or other production (stage 712). In addition, the vendor selected during stage 708 will appear as the default vendor when placing a subsequent order for the vendor service (stage 716).

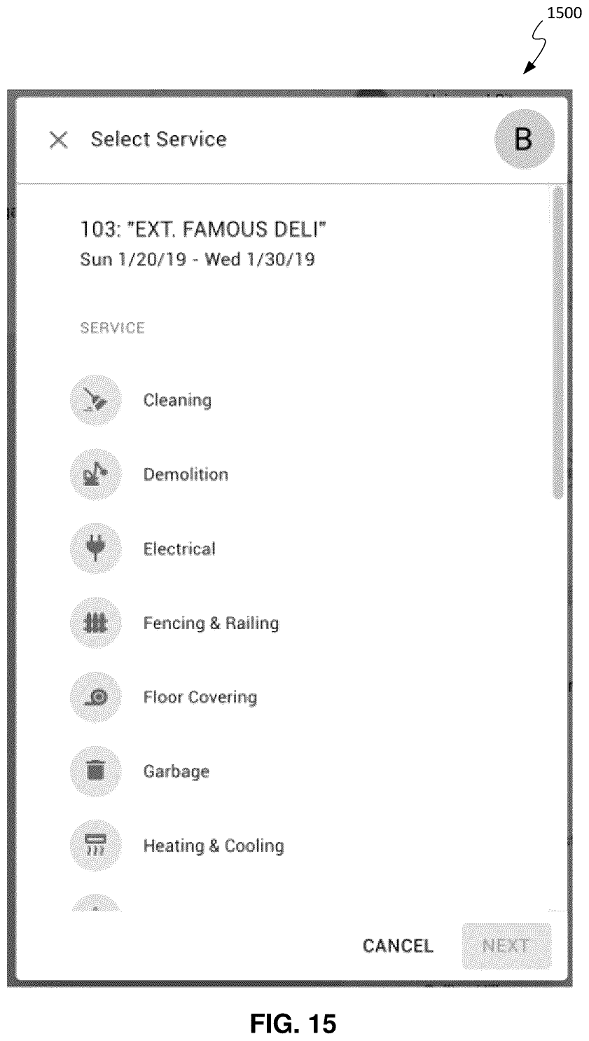

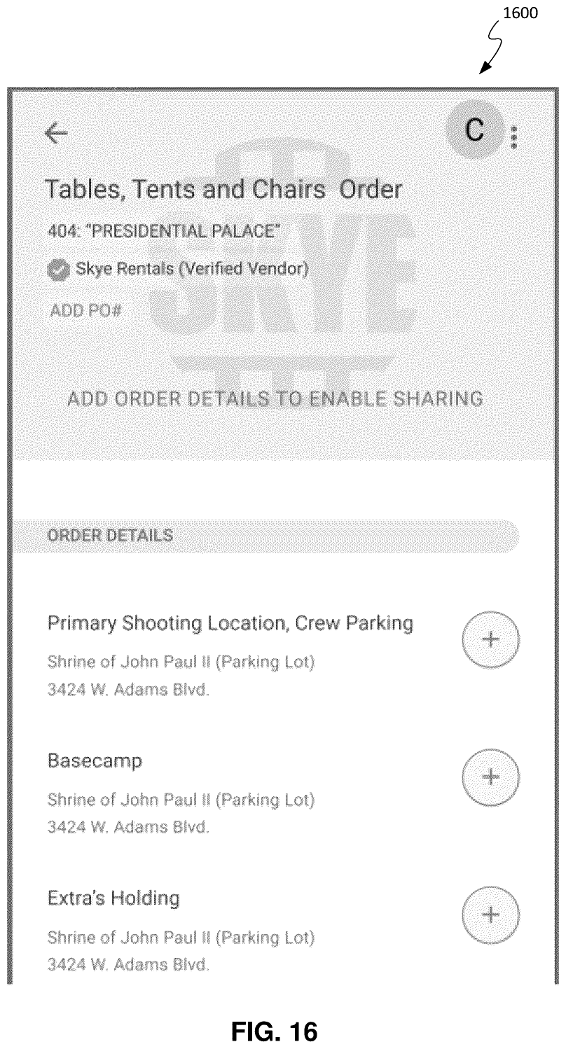

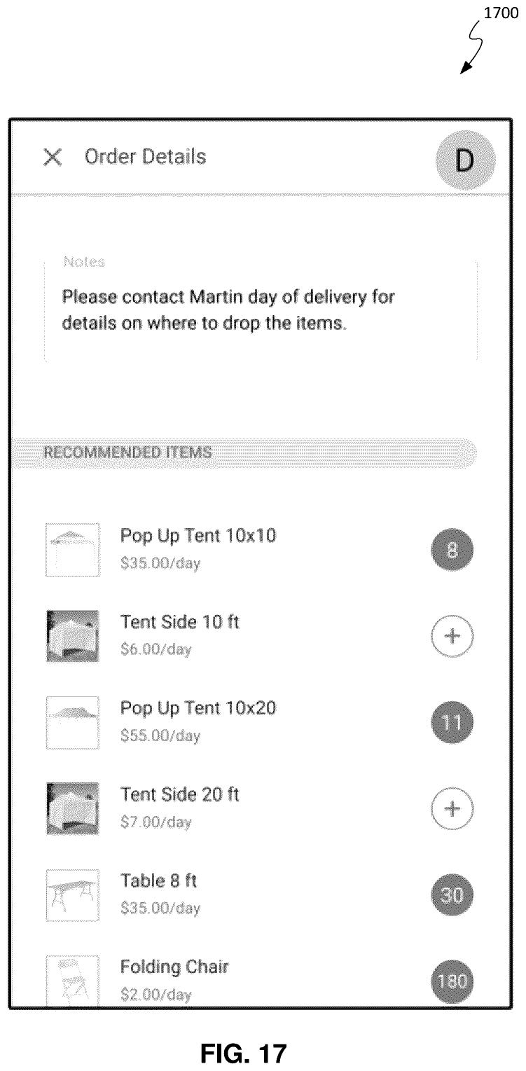

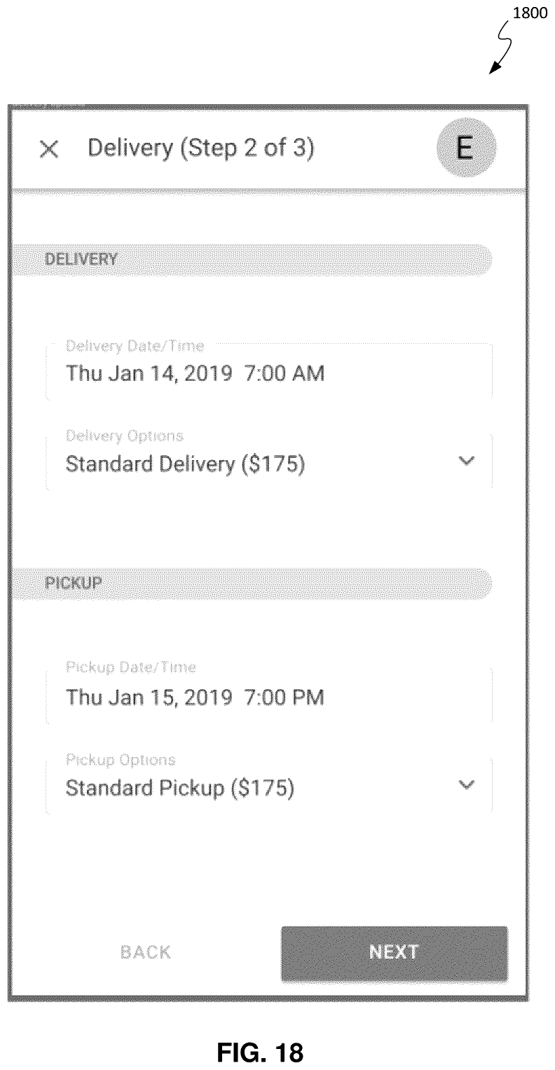

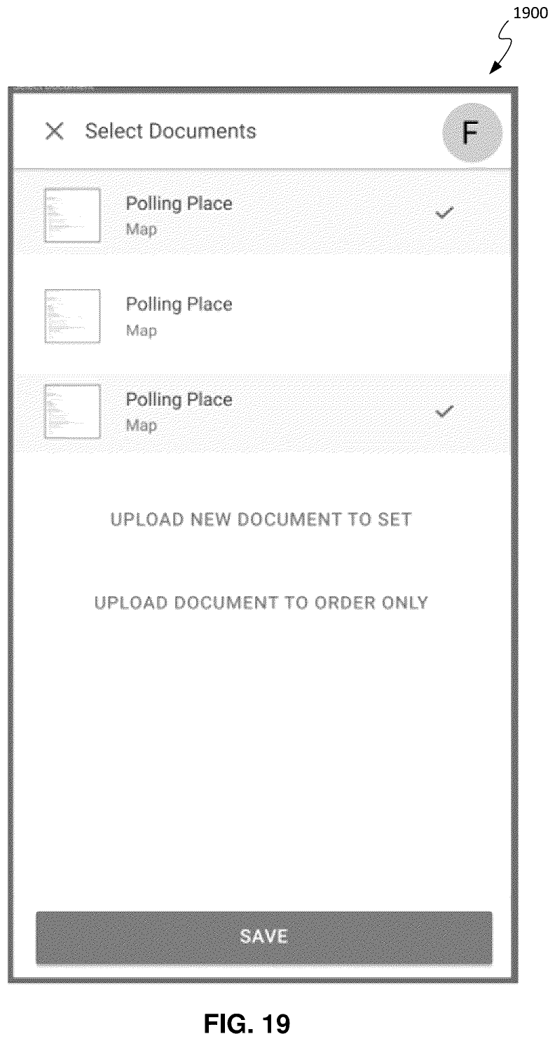

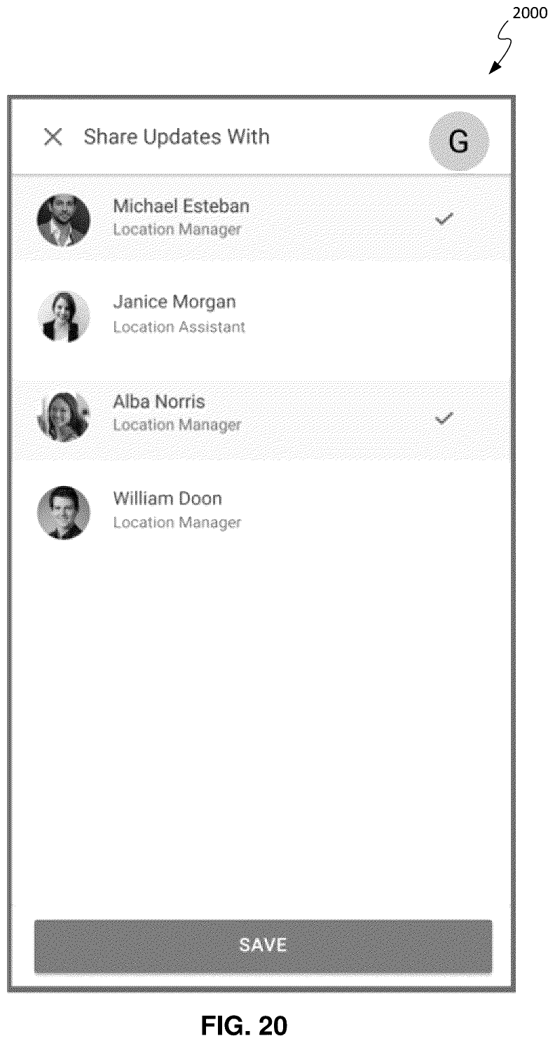

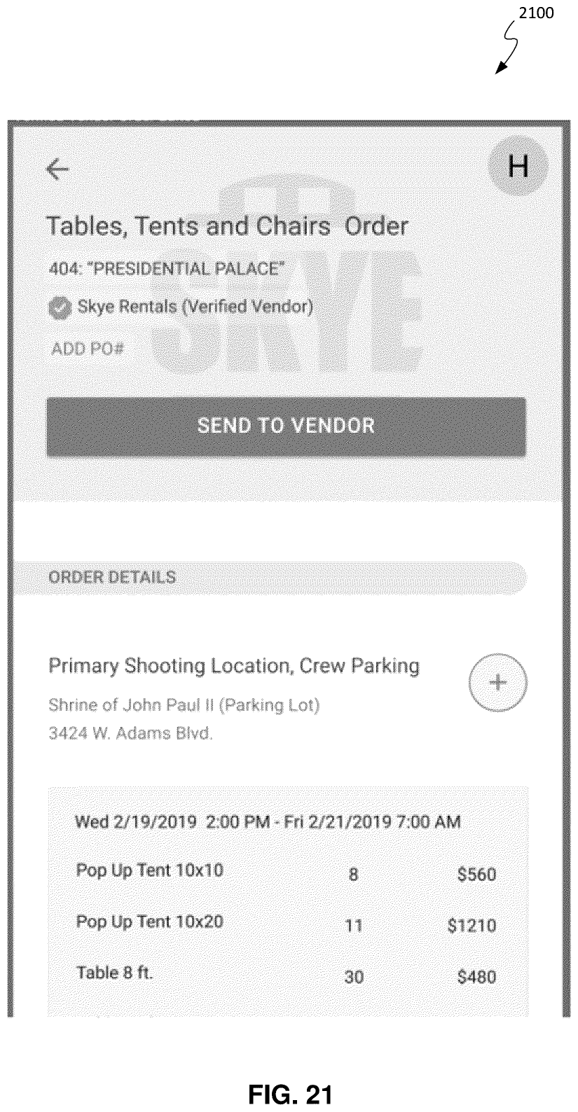

The process 700 further includes selecting an order service (stage 720). See the screenshot 1500 of FIG. 15. An order is then created that can be edited by the vendor user 120 or the production user 110 (stage 724). See the screenshot 1600 of FIG. 16. Vendor users 120 can see potential orders once services have been added (stage 728). The process 700 further includes filling in order details including PO #, inventory and notes (stage 732). See the screenshot 1700 of FIG. 17. Next, delivery dates and times are selected (stage 736). See the screenshot 1800 of FIG. 18. The process 700 further includes adding order documents from the set documents or from a new upload stage (740). See the screenshot 1900 of FIG. 19. Order watchers (e.g., production users 110, vendor users 120 and/or studio users 130) that will be notified are then added (stage 744). See the screenshot 2000 of FIG. 20. The order is then sent to the vendor user 120 for confirmation (stage 748). See the screenshot 2100 of FIG. 21. The vendor user 120 reviews and updates the order (stage 752). This approach enables the vendor 120 to leverage experience gained in connection with fulfilling similar orders for a given show to adjust details of the requested order. The vendor 120 may also know to adjust the requested order in view of specific characteristics of, for example, the production set at which the order will be fulfilled by the vendor. For example, a vendor 120 providing security may, from prior experience, be aware that certain production locations associated with a show may require a more robust security presence than other locations. Conventional approaches to procuring vendor services, whether through existing e-commerce platforms or otherwise, are not known to enable requesting users and vendors to iteratively define the service that will be provided in this manner, and thus are unable to leverage the vendor's acquired experience.

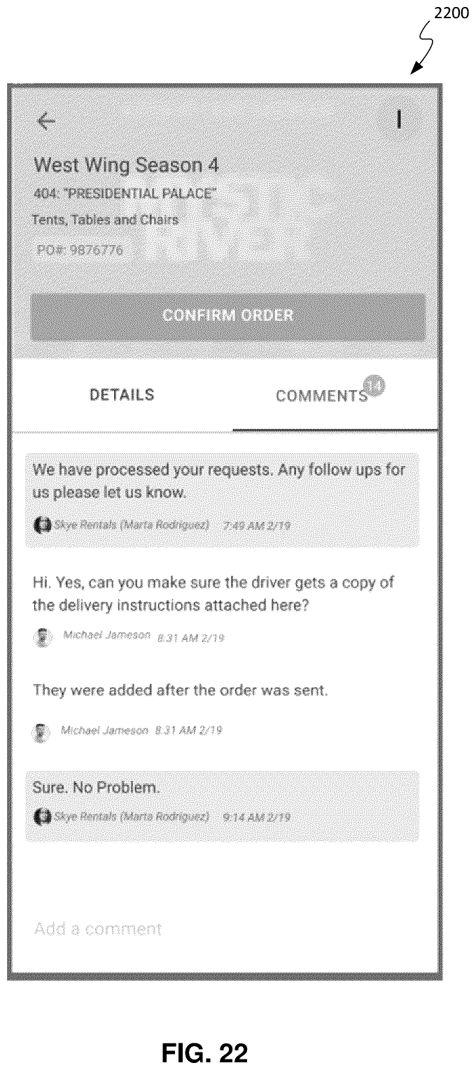

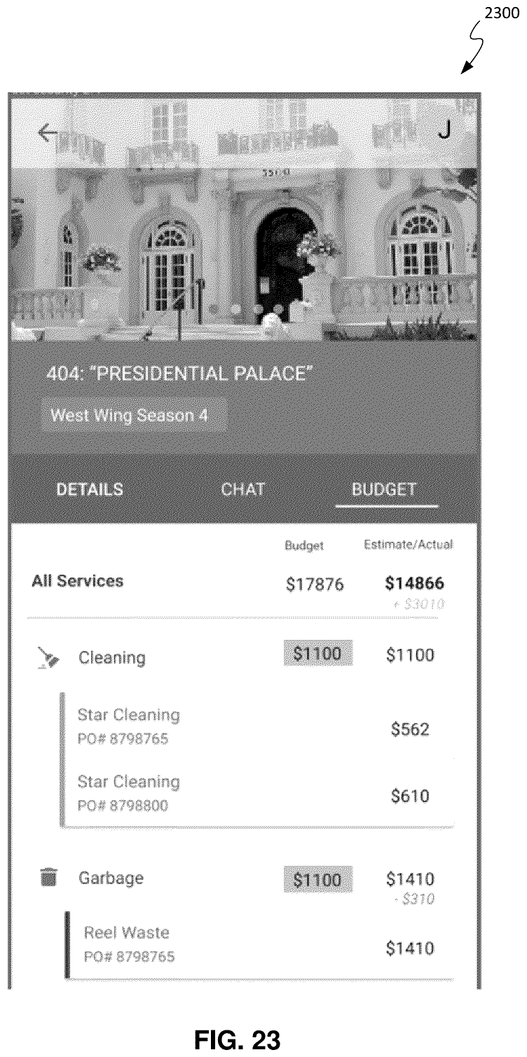

Once the vendor has reviewed and/or edited the order, the production user 110 then approves the order (stage 756). The production user 110 and the vendor user 120 then make order comments (stage 760). See the screenshot 2200 of FIG. 22. Order watchers and vendors are notified of changes (state 764). In addition, studio users 130 and others may access budget views to see the orders impact on budgets for the production set, episodes and the overall production (stage 768). See the screenshot 2300 of FIG. 23. The order is then executed (stage 772)

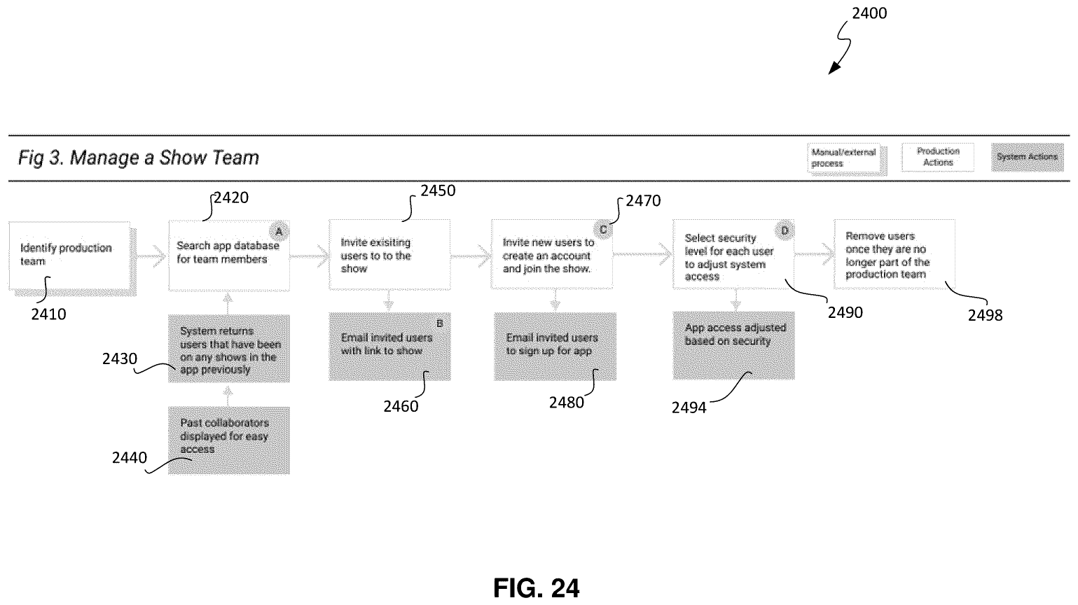

Attention is directed to FIG. 24, which is a flowchart illustrating a process 2400 of managing a show team comprised of production team members 110 having access to the application 154. In one embodiment location managers, assistant directors and other leader on the show or other production will manage the application access based on those personnel that are deemed to be on and off the team at any given time.

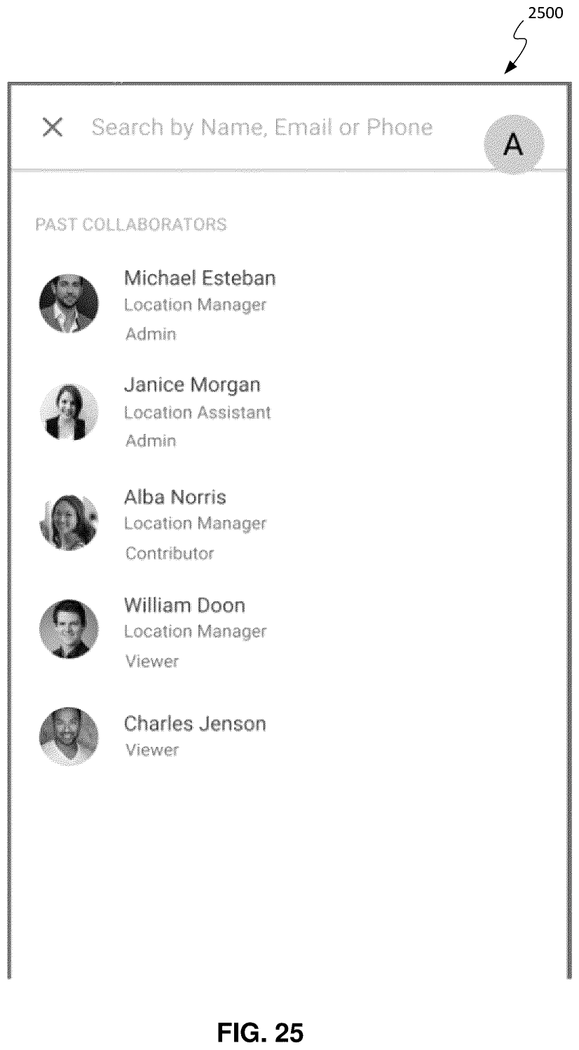

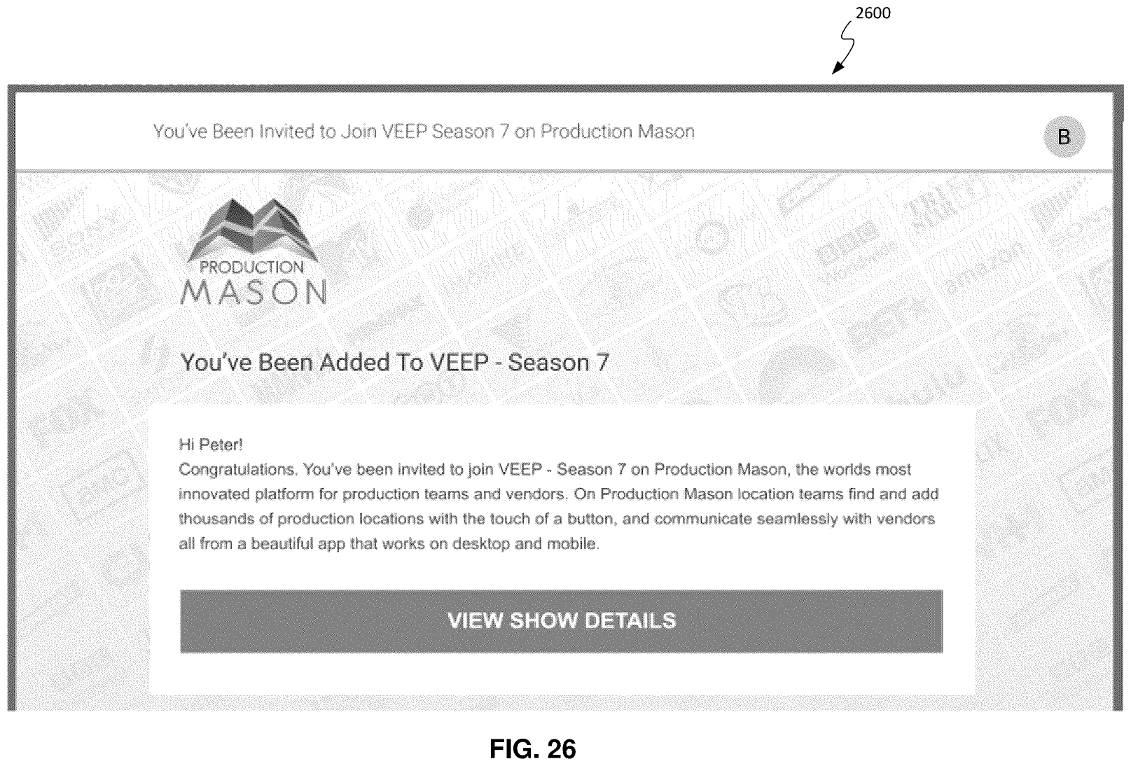

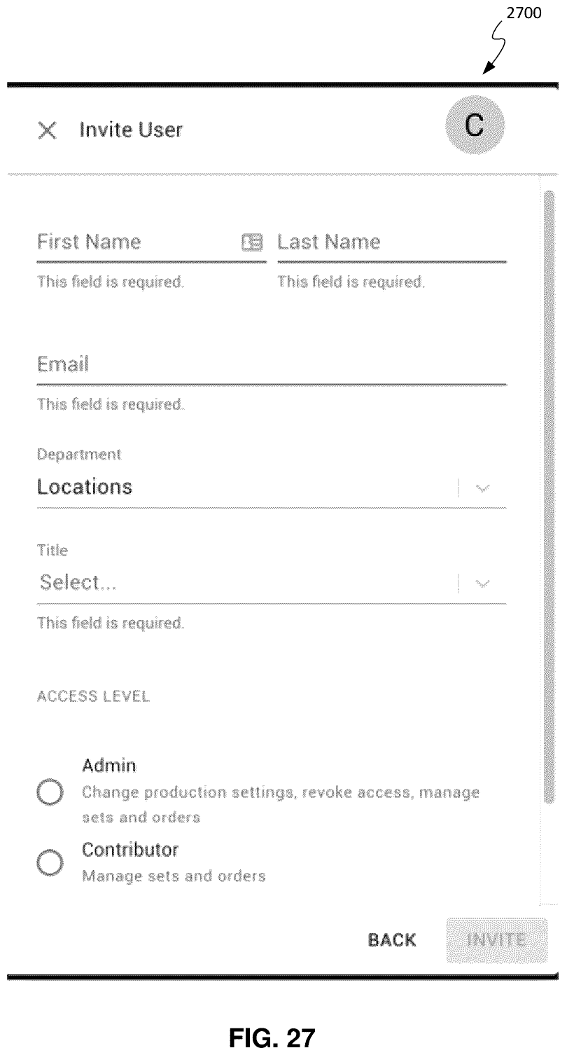

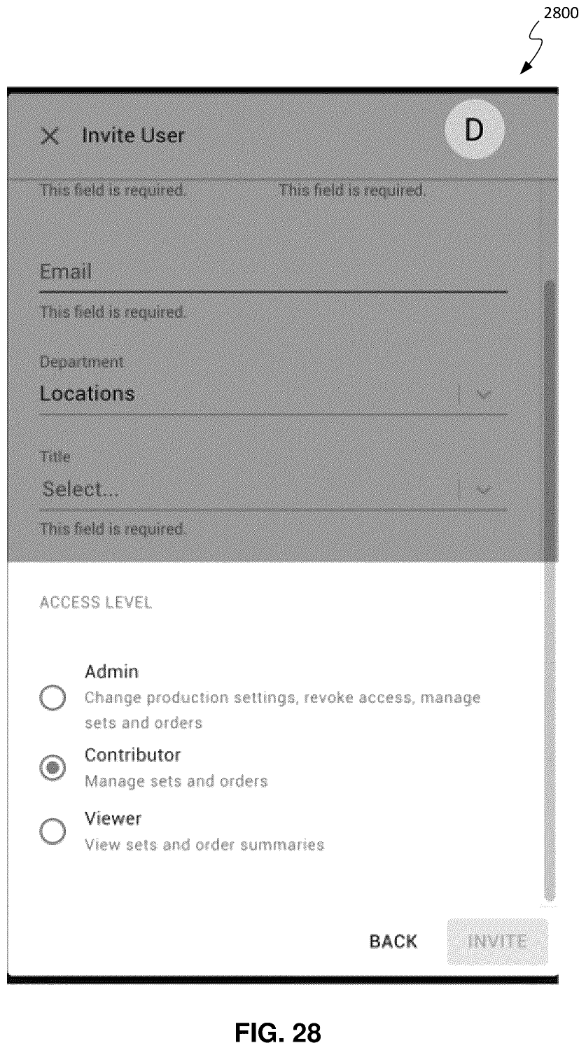

The process 2400 is initiated by identifying a production team (stage 2410). The production application 154 then causes the database 160 to be searched for team members (stage 2420). See the screenshot 2500 of FIG. 25. The system 100 returns users that have been on any shows previously managed by the system 100 (stage 2430). The process 2400 includes displaying past collaborators for easy access stage (2440). Existing users may then be invited, through the application 154, to the show (stage 2450). The system 100 then sends emails to invited users with a link to the show (stage 2460). See the screenshot 2600 of FIG. 26. New users are invited, via the application 154, to create an account and join the show (stage 2470). See the screenshot 2700 of FIG. 27. The system 100 also sends an email to invited users to sign up for the application 154 (stage 2480). A security level is then selected for each user to adjust system access (stage 2490). See the screenshot 2800 of FIG. 28. Access to the application 154 is then adjusted based on the security level accorded the user (stage 2494). In one embodiment users are removed once they are no longer part of the production team (stage 2498).

In practice, use of the process 2400 may be characterized as having the effect of creating a community or organization of members spanning an entire industry (e.g., the film industry) while simultaneously enabling this membership to be treated and managed as if part of a single company or organization within the industry. In the film industry, show teams of production users 110 are created and dissolved frequently. The process 2400 permits this creation and dissolution process to occur while simultaneously enabling members which have been released from a show or a given show to have their prior association with the show maintained. So once a member has created an account (e.g., to become connected to a particular show), the member's prior association with the show persists even after the member is disconnected from it. This could facilitate, for example, enable searching for production users 110 having particular show experience, familiarity with particular set locations, etc.

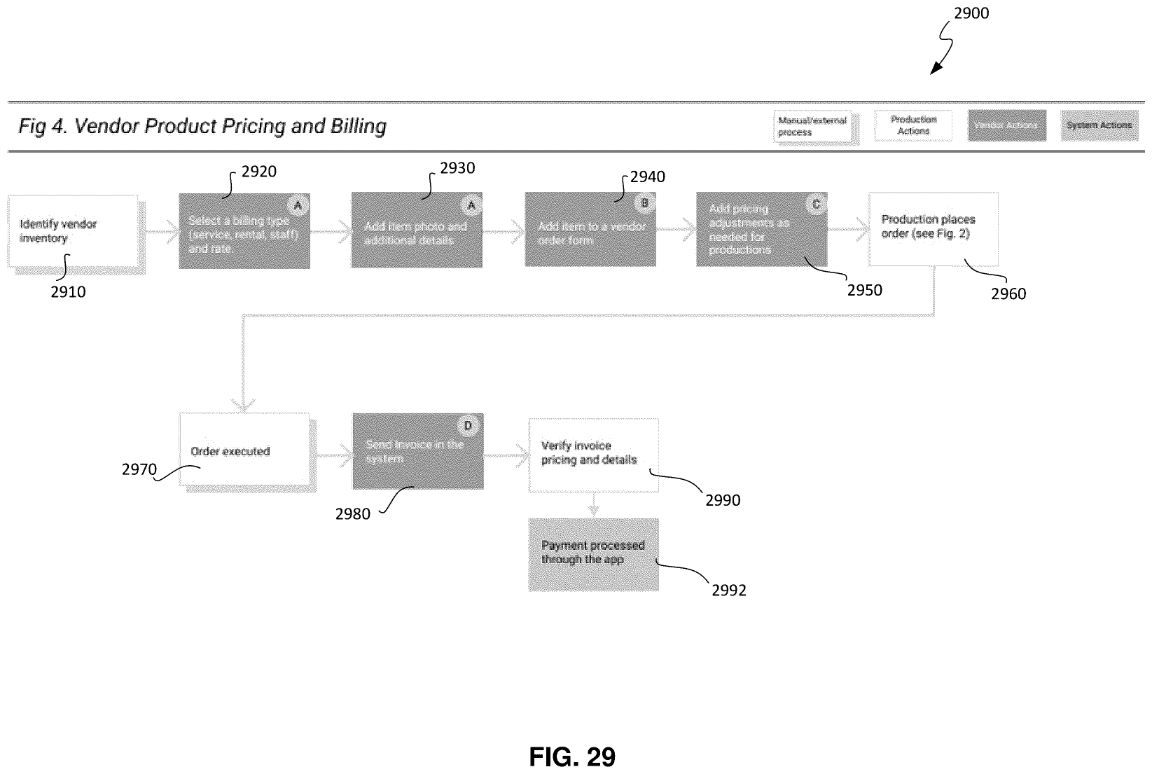

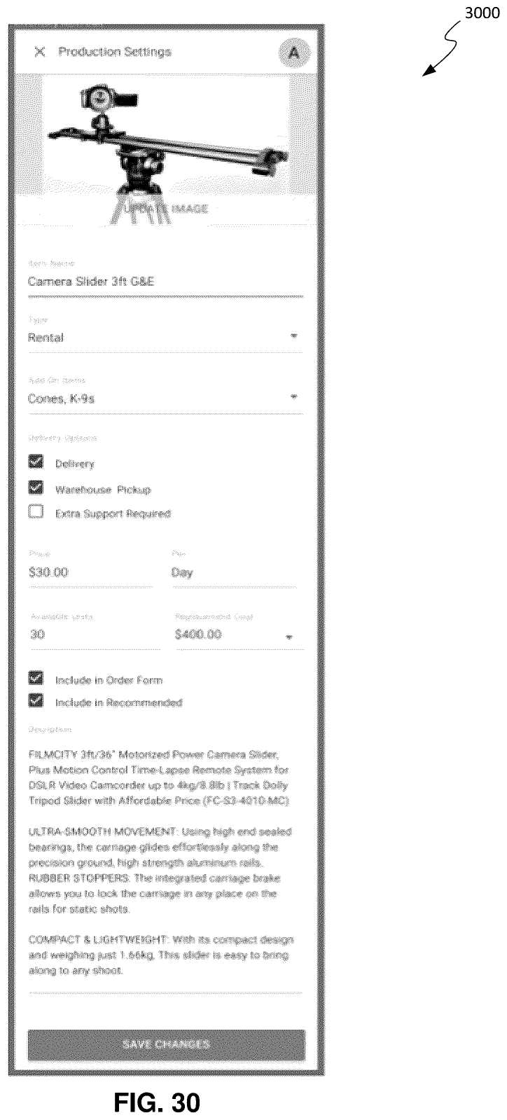

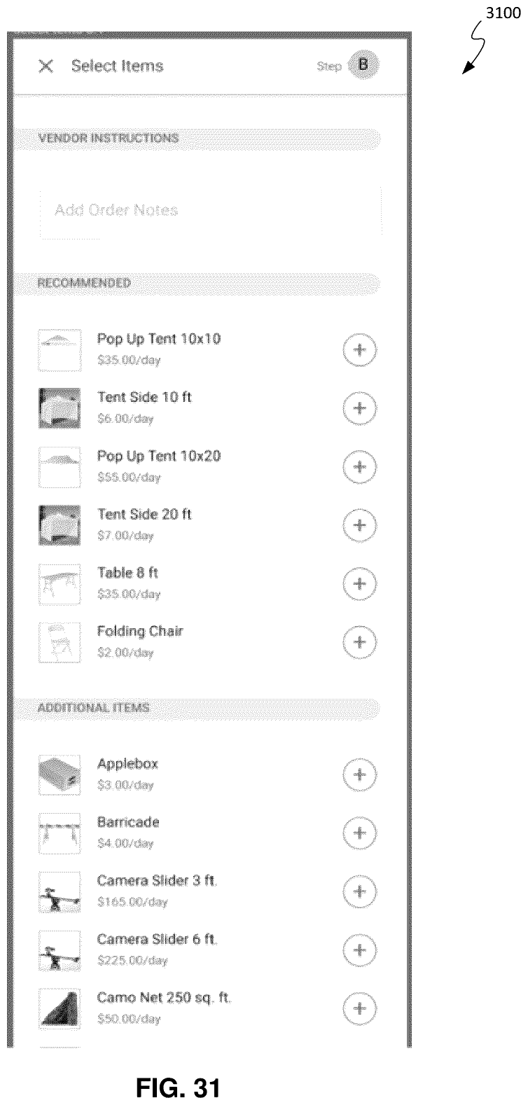

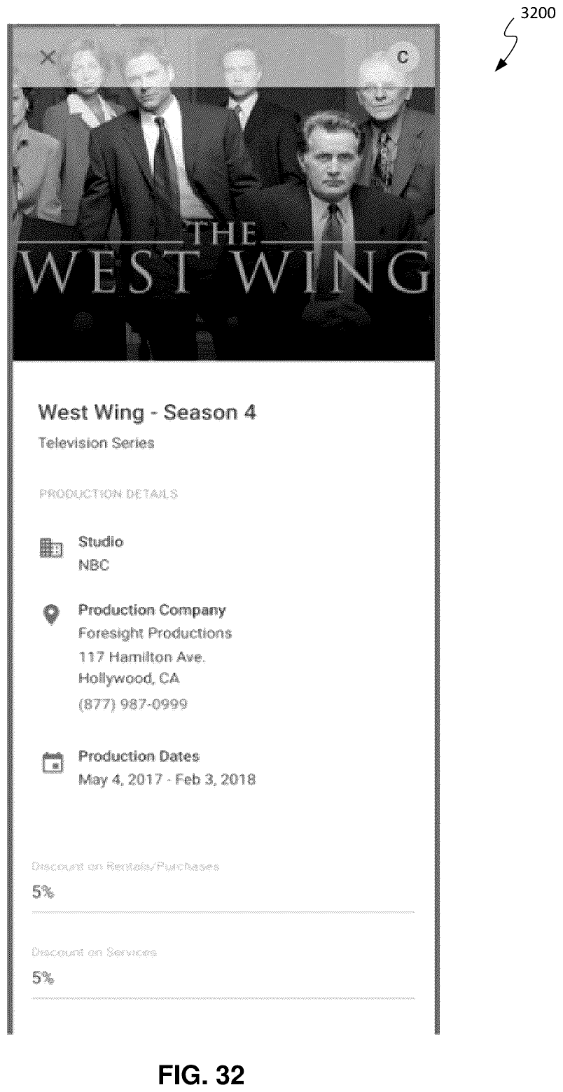

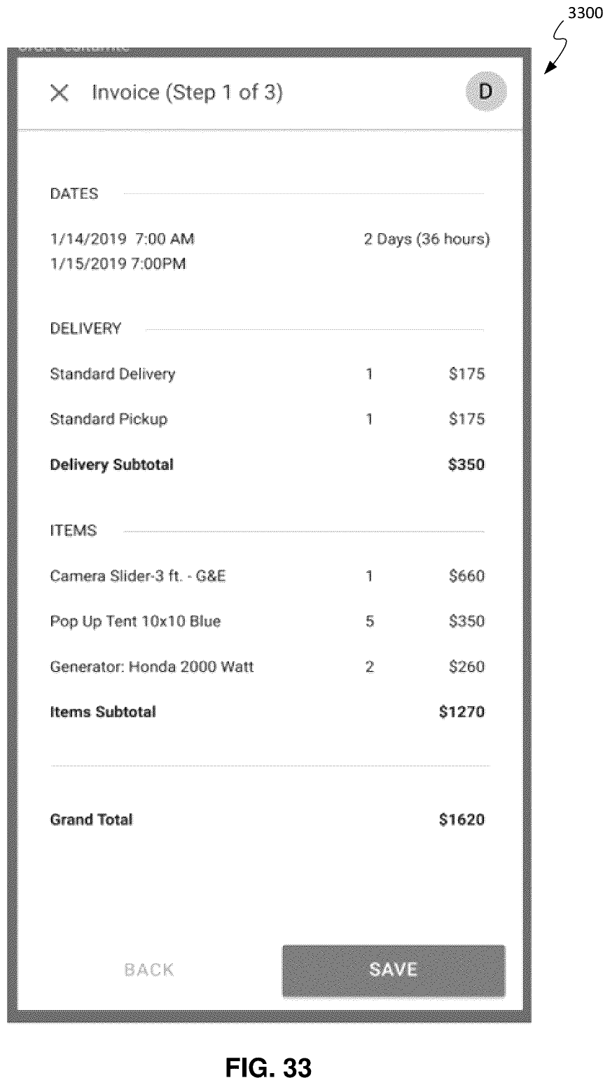

Attention is now directed to FIG. 29, which is a flowchart illustrating a process 2900 of adding orderable items into the system 100. In general, vendors 120 base their inventory on the services they provide to production and determine specific production discounts through external production agreements. The process 2900 begins by production users 110 identifying vendor inventory (stage 2910). A billing type (service, rental, staff) and rate is then selected through the vendor application 156 (stage 2920). The process 2900 includes adding, through the vendor application 156, an item photo and additional details (stage 2930). See the screenshot 3000 of FIG. 30. Next, the item is added by the vendor application 156 to a vendor order form (stage 2940). See the screenshot 3100 of FIG. 31. Pricing adjustments are then added as needed for productions via the vendor application 156 (stage 2950). See the screenshot 3200 of FIG. 32. The production team then places the order via the application 154 (stage 2960). The process 2900 includes executing the order (stage 2970). Once the order has been executed, an invoice is caused to be sent by the vendor application 156 to a member of a production team responsible for invoice processing (stage 2980). See the screenshot 3300 of FIG. 33. The process 2900 further includes verifying invoice pricing and details through the application 154 (stage 2990). Payment is then processed by the system 100 (stage 2992).

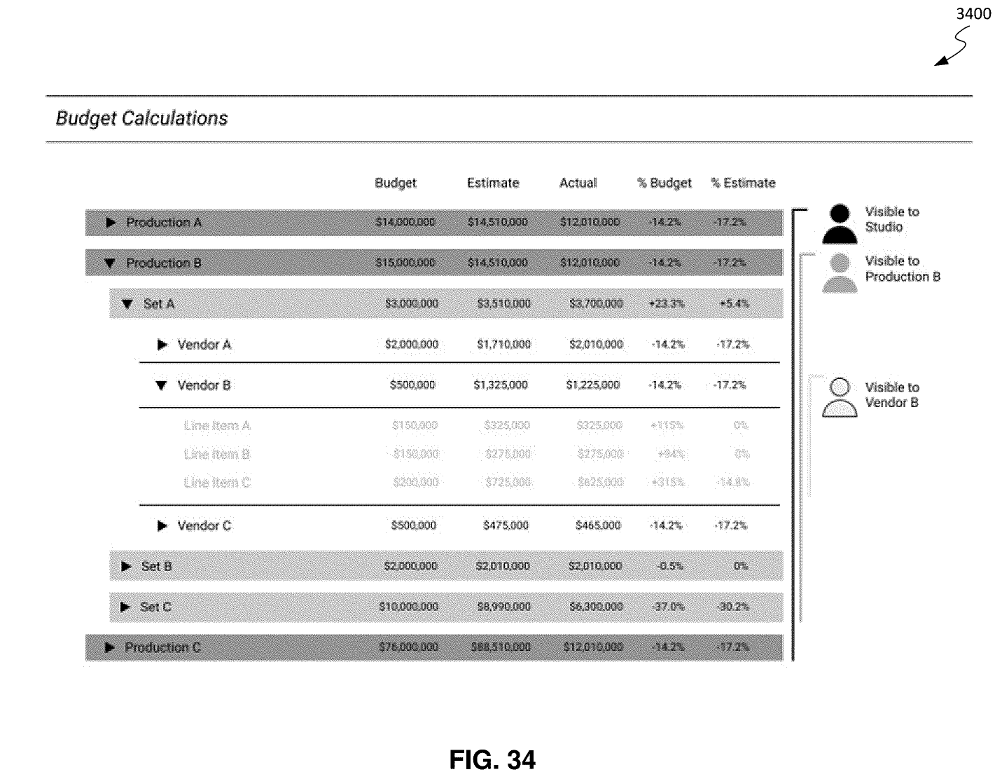

Turning now to FIG. 34, an illustration is provided of various budget calculations selectively available through the system 100 to production users 110, vendors 120 and studio users 130. In general, as vendor orders are placed and services completed, budgets will automatically be calculated and shared with all of the relevant production users 110, vendors 120 and studio users 130. Studio users 130 will typically be presented with an overview covering all of their productions. Production users 110 will generally see the budget calculations associated with each of the production sets with which they are associated as well as vendor and line item expenses. Vendors 120 will generally be presented with a view showing their expenses.

In some configurations, the apparatus or system includes means for performing various functions as described herein. In one aspect, the aforementioned means may be a module including a processor or processors and associated memory in which embodiments of the invention reside, such as are shown in the preceding drawings and which are configured to perform the functions recited by the aforementioned means. This may be, for example, modules or apparatus residing in client devices, host server systems, and/or other network devices such as are shown and/or described herein. In another aspect, the aforementioned means may be a module or apparatus configured to perform the functions recited by the aforementioned means.

In one or more exemplary embodiments, the functions, methods and processes described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As used herein, computer program products comprising computer-readable media including all forms of computer-readable medium except, to the extent that such media is deemed to be non-statutory, transitory propagating signals.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The disclosure is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The foregoing description, for purposes of explanation, used specific nomenclature to provide a thorough understanding of the invention disclosed herein. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A computer-implemented method of facilitation production of a multimedia project wherein multiple entities are associated with the multimedia project, the multimedia project being defined at least in part by a plurality of production sets, the method comprising:
receiving, at a web server, set information communicated over a communication network wherein the set information includes a plurality of set names and a plurality of dates corresponding to the plurality of production sets;
at least one of generating or updating a plurality of record elements in a database based upon the plurality of set names and the plurality of dates, the plurality of record elements corresponding to the plurality of production sets;
sending, to applications executing on electronic devices of ones of the entities associated with the multimedia project, notifications relating to changes associated with one or more of the plurality of production sets;
performing, based upon the set information, a search for potential set locations corresponding to one of the plurality of production sets wherein the performing the search includes providing a search query entered into a user interface of one of the applications to an application programming interface (API) of a location search service and receiving, at the one of the applications, a corresponding list of one or more set locations returned by the location search service in response to the search query;
generating, in response to selection of one of the potential set locations, a plurality of suggested production locations corresponding to the one of the potential set locations wherein the suggested production locations are displayed on a map rendered by a user interface of one of the electronic devices;
receiving, at the web server, selection information identifying one of the plurality of suggested production locations;
updating, based upon the selection information, a one of the plurality of record elements corresponding to the one of the plurality of production sets.

2. The method of claim 1 wherein the entities associated with the multimedia project include a vendor and a production user, the method further including creating a proposed order using a shared order form wherein the proposed order includes order information identifying the vendor and one or more services, the shared order form being accessible to an electronic device of the vendor and to an electronic device of the production user over a communications network wherein the one or more services are collaboratively defined by the vendor and the production user through editing of the shared order form.

3. The method of claim 1 wherein the generating the plurality of suggested production locations includes evaluating existing production locations.

4. The method of claim 3 wherein the generating the plurality of suggested production locations includes creating a new production location.

5. A computer-implemented method of providing information relating to vendor ordering to facilitate production of a multimedia project, the method comprising:
receiving, at a web server, vendor selection information identifying a vendor selected to provide services relating to the multimedia project;
sending, to an electronic device of the vendor, a notification of selection of the vendor;
receiving, at the web server, service selection information identifying one or more services to be provided by the vendor;
creating a proposed order using a shared order form wherein the proposed order includes order information identifying the vendor and the one or more services, the shared order form being accessible to the electronic device of the vendor and to an electronic device of a production user over a communications network wherein the one or more services are collaboratively defined by the vendor and the production user through editing of the shared order form;
receiving, at the web server, an indication of entities to be notified of changes to the proposed order;
receiving, at the web server, vendor update information containing updates to the proposed order made by the vendor; and
receiving, at the web server, an approval of the proposed order as modified to include the vendor update information.

6. The method of claim 5 further including sending update notifications indicating the changes made to the proposed order based upon the vendor update information.

7. The method of claim 5 further including receiving, at the web server, details concerning the proposed order wherein the details include at least one of a purchase order number and inventory information.

8. The method of claim 5 further including receiving, at the web server, details concerning the proposed order wherein the details include a delivery date and a delivery time.

9. The method of claim 5 further including receiving, at the web server, one or more documents relating to the proposed order and storing the documents in association with the multimedia project.

10. The method of claim 5 further including sending the proposed order to the vendor for confirmation.
